(19) United States
(12) Patent Application Publication
(10) Pub. No.: US 2010/0235607 A1
(43) Pub. Date: Sep. 16, 2010

(54) PROCESSOR

(75) Inventors: Hiroaki Sugita, Tokyo (JP); Seiji Maeda, Kanagawa (JP); Tatsuya Mizutani, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/715,895

(22) Filed: Mar. 2, 2010

(30) Foreign Application Priority Data
Mar. 13, 2009 (JP) 2009-61612

(51) Int. Cl. G06F 9/30; G06F 15/76; G06F 9/06; G06F 13/24

(52) U.S. Cl. 712/3; 712/220; 710/260; 712/E09.003; 712/E09.016

(57) ABSTRACT

A processor includes a setting register in which a mode is set, a general-purpose register including a preferred slot used during scalar computing and a slot not used during the scalar computing, a selector configured to select and output data of a register designated by a mode set in the setting register during the scalar computing, and a computing unit configured to execute the scalar computing using the preferred slot of the general-purpose register and store computing result data of the scalar computing in the preferred slot of the general-purpose register. The data of the register output from the selector is stored in the slot of the general-purpose register.

### CROSS-REFERENCE TO RELATED APPLICATIONS

This application is based upon and claims the benefit of priority from the prior Japanese Patent Application No. 2009-61612 filed in Japan on Mar. 13, 2009; the entire contents of which are incorporated herein by reference.

### BACKGROUND OF THE INVENTION

1. Field of the Invention

The present invention relates to a processor.

2. Description of Related Art

Conventionally, debugging is performed in development of a software program (hereinafter simply referred to as a program) executed on a computer.

When the debugging of the program is performed, if information concerning various registers such as a value of a program counter at a point when data is changed, a value of a stack pointer, and a value before the change of the data can be checked, such additional information is information useful for a person who develops the program, i.e., a programmer, to analyze a cause of an error.

To obtain the additional information such as the values of the various registers at a certain point during the execution of the program, it is necessary to secure a storage area for storing the additional information and insert an instruction for storing the additional information into a debug target program. However, such insertion of the instruction deteriorates execution performance of the program.

Therefore, a technique for allowing a person who performs debugging to learn, from outside, values of an internal register of a processor without affecting processing of the program has been proposed (see, for example, Japanese Patent Application Laid-Open Publication No. 2003-186854. A microprocessor of the proposal separately has a mirror register configured to copy and store content of a register used in calculation processing.

However, according to the method of the proposal, an external memory is necessary because a register for debugging is separately provided and an external memory for storing information for debugging is necessary.

### BRIEF SUMMARY OF THE INVENTION

According to an aspect of the present invention, it is possible to provide a processor including: a setting register in which a mode is set; at least one general-purpose register including a first area used during a predetermined computing and a second area not used during the predetermined computing; a computing unit configured to execute the predetermined computing using the first area of the at least one general-purpose register and store computing result data of the predetermined computing in the first area of the at least one general-purpose register; and an output circuit configured to select data of the at least one register according to the mode set in the setting register during the predetermined computing and output the data to the second area or execute determination processing corresponding to the mode set in the setting register using the data stored in the first area and the second area during the predetermined computing and output a predetermined signal to the computing unit with respect to a result of the determination processing.

### BRIEF DESCRIPTION OF THE DRAWINGS

FIG. 1 is a diagram for explaining a configuration of a general-purpose register according to a first embodiment of the present invention;

FIG. 2 is a block diagram showing a configuration example of a computer system including processors according to the first embodiment of the present invention;

FIG. 3 is a block diagram showing a configuration example of each of the processors according to the first embodiment of the present invention;

FIG. 4 is a block diagram showing a configuration example of a selecting unit according to the first embodiment of the present invention;

FIG. 5 is a flowchart showing an example of a flow of processing during debug processing execution according to the first embodiment of the present invention;

FIG. 6 is a block diagram showing a configuration of a processor according to a second embodiment of the present invention; and

FIG. 7 is a block diagram showing a configuration example of a determining unit according to the second embodiment of the present invention.

### DETAILED DESCRIPTION OF THE EMBODIMENTS OF THE INVENTION

Embodiments of the present invention are explained below with reference to the accompanying drawings.

### First Embodiment

### Configuration

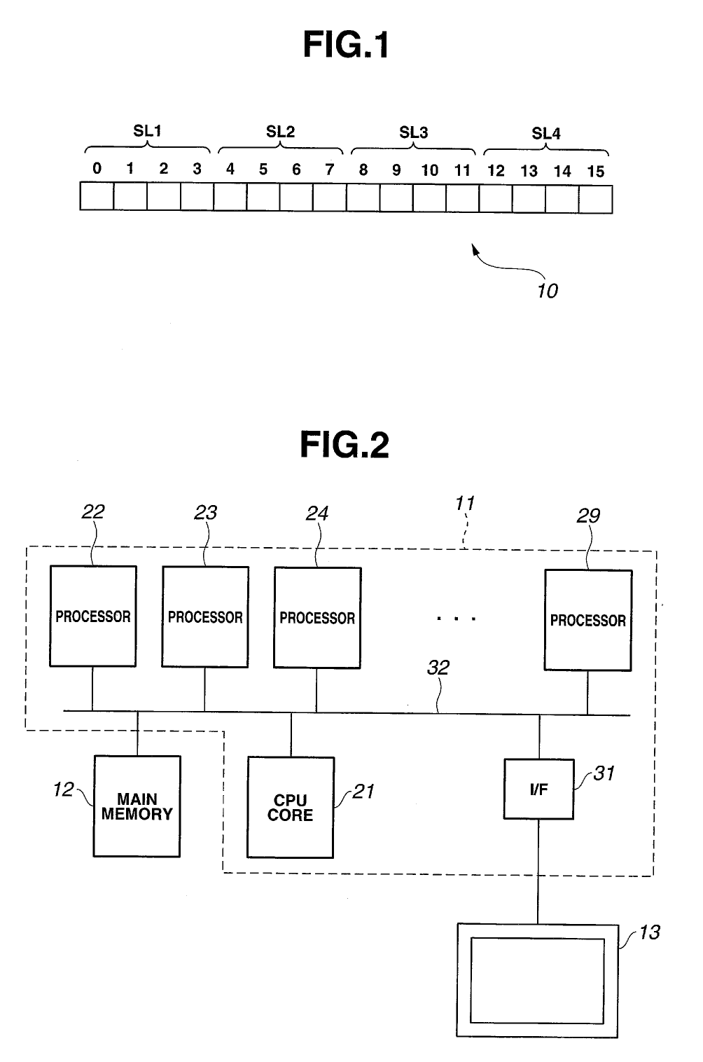

First, a configuration of a processor according to a first embodiment of the present invention is explained with reference to FIGS. 1 to 3. The processor includes a computing unit and various registers. The various registers include general-purpose registers (GPRs).

The general-purpose register is a register used in various kinds of processing to store a computing result and used in next or other kinds of calculation processing.

The processor according to this embodiment is an SIMD-type processor that can execute a vector computing. The computing unit is configured to be processable with data having bit width of, for example, 128 bits (16 bytes) set as a processing unit. A plurality of the general-purpose registers, for example, one hundred twenty-eight general-purpose registers are provided. 128-bit data can be stored in each of the general-purpose registers.

In the processor, since processing during the vector computing is performed in 128-bit units, all 128 bits of each of the general-purpose registers in use are used. The processor can also execute a scalar computing. During the scalar computing, only a preferred slot as a part of each of the general-purpose registers in use is used.

FIG. 1 is a diagram for explaining the configuration of the general-purpose register according to this embodiment. As shown in FIG. 1, each of general-purpose registers 10 has width of 128 bits (16 bytes). When processing concerning scalar data or an address is executed, data included in a predetermined portion (hereinafter referred to as preferred slot) on the general-purpose register 10 is used for the processing. In FIG. 1, a portion of byte indexes 0 to 3 is a preferred slot SL1. 128 bits are divided into four slots SL1 to SL4. 32-bit data is stored in each of the slots.

For example, when the processor executes a 32-bit integer computing, data used for the computing is stored in positions of the byte indexes 0 to 3 of the preferred slot SL1. However, portions of the remaining byte indexes 4 to 15 are empty slots not used for the scalar computing. A result of the scalar computing is also stored only in the slot SL1 serving as the preferred slot.

On the other hand, when the processor executes the vector computing, the processor performs readout and storage of data using all the byte indexes 0 to 15 of the general-purpose register 10. Specifically, the general-purpose register 10 includes the preferred slot SL1 as a storage area used for the scalar computing and the slots SL2 to SL4 as storage areas not used for the scalar computing.

Therefore, the processor according to this embodiment effectively uses the general-purpose registers by storing both a scalar value and a vector value in the same general-purpose register 10. Therefore, since a general-purpose register for the scalar computing and a general-purpose register for the vector computing are not separately provided, the number of general-purpose registers can be reduced. As explained later, in this embodiment, information useful for analysis of a cause of a deficiency of a program during debugging is stored in the storage area of the general-purpose register not used for storage of the scalar value, whereby effective use of the general-purpose register is realized.

FIG. 2 is a block diagram showing a configuration example of a computer system including the processor according to this embodiment.

As shown in FIG. 2, the computer system includes a main body unit 11 including a plurality of the processors, a main memory 12, and a monitor 13 connected to the main body unit 11.

The main body unit 11 is, for example, a chip of parallel-processable semiconductor devices integrated in one chip including a CPU core 21 serving as a main unit and processors 22 to 29 respectively configured to perform independent kinds of signal processing. The main body unit 11 further includes an interface (I/F) 31 for connection to the monitor 13. The processors in the main body unit 11, the interface 31, and the main memory 12 are connected to one another via an internal bus 32.

The main CPU core 21 is a processor configured to collectively control the eight processors 22 to 29 and includes a primary cache, a secondary cache, and a calculation unit.

Each of the processors 22 to 29 includes a calculation unit and a local memory as a storing unit. Each of the processors 22 to 29 includes the general-purpose register group described above and can execute both the vector computing and the scalar computing using the general-purpose register group.

For example, when a program including SIMD computing processing is executed in each of the processors, during SIMD computing, four pieces of 32-bit data are stored in one general-purpose register 10 and the four pieces of data are simultaneously processed. During the scalar computing, only the preferred slot SL1 as a storage area in a part of one general-purpose register 10 is used for the scalar computing.

A program and data executed in the main CPU core 21 and the processors 22 to 29 are stored in the main memory 12. The program stored in the main memory 12 is loaded to the CPU core 21 and the processors 22 to 29 and executed.

The interface (I/F) 31 for the monitor 13 is connected to the bus 32. For example, during debugging, a debug program is executed on the CPU core 21 and the processors 22 to 29 and a screen for debugging is displayed on a screen of the monitor 13.

Therefore, the main body unit 11 and the main memory 12 configure a computer system and can execute various programs on each of the processors. A user can implement the debug program on the main body unit 11 and cause the computer system to function as a debugger as well. During debugging, the user can cause the computer system to display contents of various registers and the like on the screen of the monitor 13 and can perform debugging of the program including the SIMD computing processing.

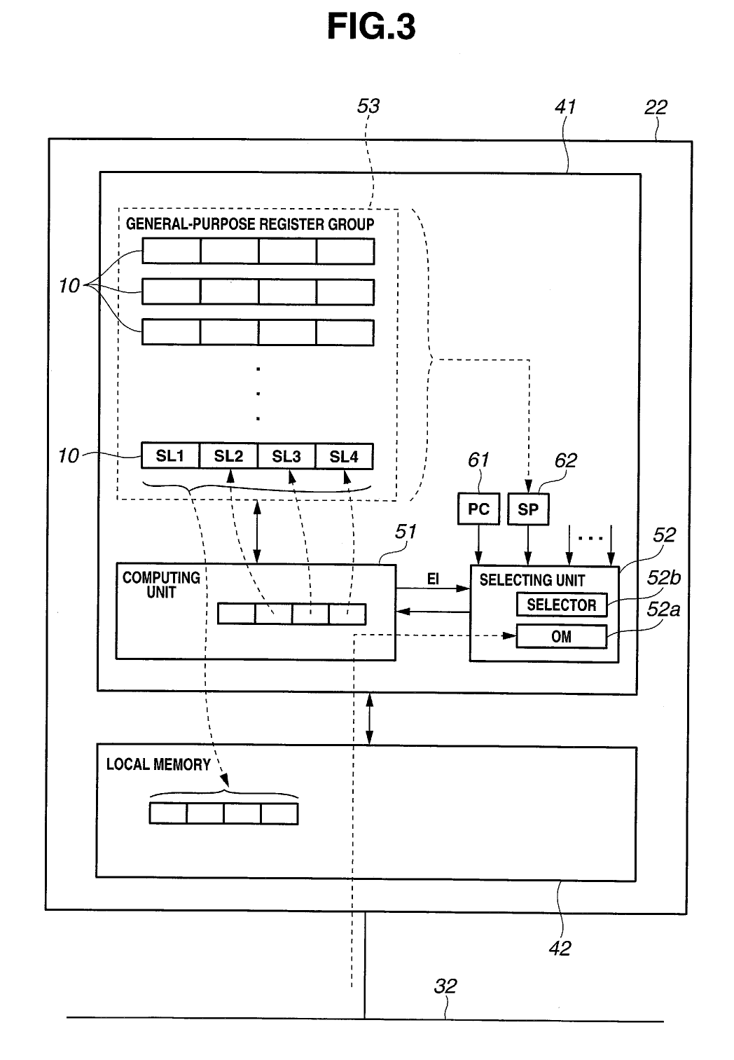

FIG. 3 is a block diagram of a configuration example of each of the processors. The configuration of the processor 22 is explained below. However, since the configuration of the other processors 23 to 29 is the same as the configuration of the processor 22, explanation of the configuration of the other processors 23 to 29 is omitted.

As shown in FIG. 3, the processor 22 includes a calculation unit 41 and a local memory 42 as a storing unit and is connected to the bus 32. The calculation unit 41 includes a computing unit 51, a selecting unit 52, and a general-purpose register group 53. The general-purpose register group 53 includes a plurality of the general-purpose registers 10 each having four slots shown in FIG. 1.

The computing unit 51 uses the program and data stored in the local memory 42 to execute the program. As explained above, the processor 22 can execute both the vector computing and the scalar computing. The computing unit 51 can determine, according to an instruction to be executed, whether the scalar computing is executed or the vector computing is executed.

When the computing unit 51 executes the vector computing, the computing unit 51 executes the SIMD computing using a predetermined general-purpose register 10. During the SIMD computing, all the four slots are used.

When the computing unit 51 executes the scalar computing, the computing unit 51 executes the scalar computing using the predetermined general-purpose register 10. However, the computing unit 51 uses only one of the four slots, for example, the preferred slot SL1 for the scalar computing.

As explained later, data designated in the selecting unit 52 by a mode to be explained later is stored in all or a part of the three slots SL2 to SL4 not used for the scalar computing.

The selecting unit 52 includes a setting register 52a. A mode, i.e., an operation mode OM is set in the setting register 52a. A plurality of kinds of operation modes OM are set in advance. One of the operation modes OM can be set in the setting register 52a from outside.

The selecting unit 52 is connected to be capable of acquiring data of the various registers in the calculation unit 41. FIG. 3 shows that a register 61 configured to store a value of a program counter (PC), a register 62 configured to store a value of one slot in one general-purpose register configured to store a value of a stack pointer (SP), a register (not shown) configured to store an execution instruction (EI) in the computing unit 51, and the like are connected to the selecting unit 52.

Output content of the selecting unit 52 to the computing unit 51 is determined on the basis of the operation mode OM set in the setting register 52a. In other words, the selecting unit 52 is an output circuit configured to select data of at least one register designated by the operation mode OM set in the setting register 52a during the scalar computing.

The setting of the operation mode OM in the setting register 52a is performed during debugging or before execution of debugging from the CPU core 21 via the bus 32 on the basis of an instruction of a user who performs debugging or on the basis of a program.

The selecting unit 52 selects data of the various registers according to the set operation mode OM and outputs the data to the computing unit 51. For example, when a certain operation mode OM is a mode for selecting a value of the program counter (PC), a value of the stack pointer (SP), and the execution instruction (EI) being executed in the computing unit 51 and outputting the values and the execution instruction (EI) to the computing unit 51, the selecting unit 52 outputs these designated data to the computing unit 51.

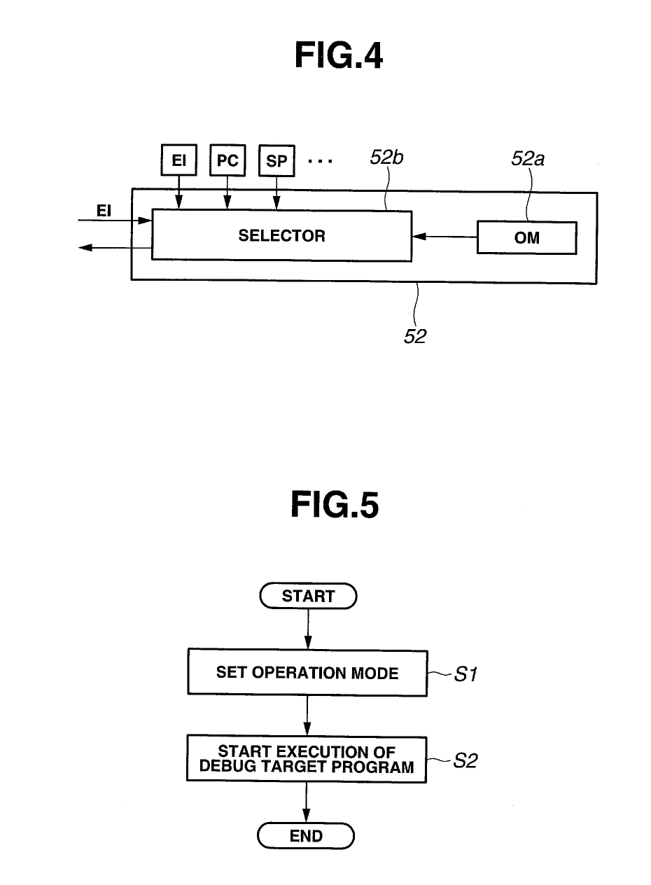

FIG. 4 is a block diagram of a configuration example of the selecting unit 52. The selecting unit 52 includes a setting register 52a and a selector 52b. The selector 52b of the selecting unit 52 is connected to the computing unit 51, the general-purpose register group 53, the program counter 61, and the like and can acquire data such as the execution instruction (EI), a value of the program counter (PC), and a value of the stack pointer (SP). The selector 52b selects only data corresponding to the operation mode OM set in the setting register 52a. The selected one piece or two or more pieces of data are output to the computing unit 51 in predetermined order or respectively output via predetermined signal lines. The data from the selecting unit 52 are output in association with each of the slots SL2 to SL4. In other words, the selecting unit 52 is a circuit configured to select, during the scalar computing, according to the operation mode OM, data supplied from the various registers in the processor 22 to the computing unit 51 and output the data to a corresponding slot.

In the scalar computing, when the scalar computing ends and the computing unit 51 stores a result of the computing in the preferred slot SL1 of the predetermined general-purpose register 10, the computing unit 51 stores the output data of the selecting unit 52 in the corresponding slots SL2 to SL4 as additional information together with the result. For example, when the computing unit 51 stores a result of a 32-bit integer computing in the preferred slot SL1 of the predetermined general-purpose register 10, the computing unit 51 stores, in the slots SL2 to SL4 as vacant slots of the general-purpose register 10, additional information selected on the basis of the operation mode OM as setting information set in the selecting unit 52 beforehand.

In the example explained above, the data selected in the selecting unit 52 is stored in the vacant slots SL2 to SL4 via the computing unit 51. However, the processor 22 may be configured to directly store the data in the vacant slots SL2 to SL4 from the selecting unit 52 without the intervention of the computing unit 51.

In that case, the data selected in the selecting unit 52 is stored in the vacant slots SL2 to SL4 by the selecting unit 52.

### Operation

Operation of the computer system is explained below. When the debug program is executed in the main body unit 11 of the computer system, setting of an operation mode in the setting register 52a of the selecting unit 52 of each of the processor is performed in advance.

For example, when the user finds a deficiency in a development program, the user may desire to cause the computer system to execute a portion of the scalar computing related to occurrence of the deficiency and check contents of the execution instruction (EI) and the stack pointer (SP). In such a case, the user sets in advance, in the setting register 52a, an operation mode for storing the execution instruction (EI) in the slot SL2 and storing a value of the stack pointer (SP) in the slot SL3 during the scalar computing.

During the scalar computing, the user may desire to check contents of the execution instruction (EI), the stack pointer (SP), and the program counter (PC). In such a case, the user sets in advance, in the setting register 52a, an operation mode for storing the execution instruction (EI) in the slot SL2, storing a value of the program counter (PC) in the slot SL3, and storing a value of the stack pointer (SP) in the slot SL4 during the scalar computing.

Further, the user may desire to cause the computer system to execute a part of the scalar computing related to the occurrence of the deficiency and check immediately preceding data during the scalar computing. In such a case, the user sets, in the setting register 52a of the selecting unit 52, an operation mode for storing immediately preceding data. For example, in the case of the 32-bit integer computing, the selecting unit 52 selects values obtained when a scalar computing value is updated up to three times in the past. An operation mode that can store the third preceding value in the slot SL4, store the second preceding value in the slot SL3, and store the immediately preceding value in the slot SL2 and output the stored data is set in the selecting unit 52. In other words, change history data of the scalar computing can be stored in an unused area of the general-purpose register 10.

The same is possible in values other than the 32-bit integer. For example, an operation mode for storing, in the case of an 8-bit integer computing, a change history of changes performed up to fifteen times in the past and storing, in the case of a 64-bit floating point computing, a change history of a change performed once in the past can be set. Such change history data in the past is useful in finding a cause of inappropriateness when, for example, a value that should continuously increase in such a manner as 1, 2, 3, and 4 suddenly changes to a discontinuous value.

The example explained above concerning the example of the data stored in the vacant slots in the setting of the operation mode is only an example and will be explained more in detail later.

FIG. 5 is a flowchart showing an example of a flow of processing during debug processing execution. First, before causing the computer system to execute a debug target program, the user performs setting of an operation mode on the debug processing program (step S1). As a result, as indicated by a dotted line in FIG. 3, the operation mode OM is set in the setting register 52a.

The setting of an operation mode is performed by, for example, causing the computer system to display a setting screen on the screen of the monitor 13 and selecting an operation mode indicating a register which the user desires to store in each of one or two or more vacant registers, out of a plurality of displayed operation modes.

After performing the setting of the operation mode, the user causes the computer system to execute a program having a deficiency on the debug program (step S2). In other words, execution of the debug target program is performed.

When the program is executed, if an execution instruction is an SIMD instruction, the SIMD computing is performed, using all the four slots.

If the execution instruction is an instruction of the scalar computing, when the computing unit 51 stores a computing result in the preferred slot SL1 in the predetermined general-purpose register 10, the computing unit 51 also stores the data from the selecting unit 52 in designated slots in the slots SL2 to SL4.

The data of the general-purpose register 10 used for the scalar computing can be stored in a predetermined area of the local memory 42 according to a store instruction of the computing unit 51. Therefore, the user can cause the computer system to display desired data on the monitor 13 during the scalar computing and can check the desired data.

### Example of Data Stored in the Vacant Slots

An example of data stored in the vacant slots SL2 to SL4 is explained below.

1) A previous value stored in the preferred slot

This data is data stored in the preferred slot SL1 immediately before data is written in the preferred slot SL1 and is stored in a vacant slot, for example, the slot SL2.

Plural pieces of data may be stored in a plurality of vacant slots. In that case, plural pieces of data in the nearest past, i.e., history data are stored. For example, as explained above, when the 32-bit integer data is stored in the preferred slot SL1, written data written up to three times in the nearest past can be stored in the slots SL2 to SL4.

2) An instruction having performed a computing

This data is an instruction set of a program for, when data is stored in the preferred slot, instructing the storage of the data and is stored in a vacant slot.

Plural pieces of data may be stored in the vacant slot. In that case, a plurality of execution instructions in the nearest past are stored. For example, when an instruction set is fixed to 32 bits and 32-bit integer computing result data is stored in the preferred slot SL1, execution instructions performed three times in the nearest past can be stored in the slots SL2 to SL4.

3) A value of the program counter (PC) during instruction execution

This data is a value of the program counter (PC) of a program for, when data is stored in the preferred slot SL1, instructing the storage of the data and is stored in a vacant slot.

Further, when plural pieces of data can be stored in the vacant slot, values of a plurality of the program counters (PC) in the nearest past are stored. For example, when values of the program counters (PC) are 32 bits and 32-bit integer computing result data is stored in the preferred slot SL1, values of the program counters (PC) acquired three times in the nearest past can be stored in the slots SL2 to SL4.

4) A value of the stack pointer (SP)

This data is a value of the stack pointer (SP) acquired by, when data is stored in the preferred slot SL1, executing a program for instructing the storage and is stored in a vacant slot.

Further, when plural pieces of data can be stored in the vacant slot, values of a plurality of the stack pointers (SP) in the nearest past are stored. For example, when values of the stack pointers (SP) are 32 bits and 32-bit integer computing result data is stored in the preferred slot SL1, values of the stack pointers (SP) acquired three times in the nearest past can be stored in the slots SL2 to SL4.

5) Combination of the above

In 1) to 4), plural pieces of data such as the computing result, the execution instruction, and the value of the program counter (PC) are stored as history data in the past. However, as in the example explained above, these pieces of data may be combined. By storing data of the various registers, it is possible to obtain and check data of various internal registers during debugging and more efficiently perform the debugging.

As explained above, if the processor according to this embodiment is used, by deciding in advance a plurality of operation modes for storing one or more various pieces of data during the scalar computing and setting a desired operation mode in the setting register 52a of the selecting unit 52, it is possible to freely obtain additional information corresponding to an intension of a person who performs debugging.

In the above explanation, the vacant slot of the general-purpose register 10 in the processors 22 to 29 is explained. However, a vacant slot of a general-purpose register may be effectively used as explained above in the processor 21 of the CPU core.

The example explained above is an example of a semiconductor device mounted with a plurality of processors. However, it goes without saying that the present invention can also be applied to a semiconductor device mounted with only one processor.

As explained above, according to this embodiment, during the scalar computing, desired data is automatically stored in a vacant slot when computing result data of a general-purpose register is stored. Without depending on a dedicated store instruction for each size of a preferred slot, a value stored in the vacant slot can be stored in the local memory together with a value stored in the preferred slot. Consequently, a program developer can not only easily check desired register data during the scalar computing but also easily change desired data which the program developer desires to check, by changing an operation mode.

With the processor according to this embodiment, it is possible to store, without requiring a new hardware circuit for storing values of various registers in the processor, the values of the various registers.

### Second Embodiment

A processor according to a second embodiment of the present invention is explained below.

In the processor according to this embodiment, a vacant slot in a general-purpose register is used as a storage area for storing data for determination used during execution of predetermined determination processing. When a mode of the determination processing is set, the processor according to this embodiment executes, during a scalar computing processing for comparing data such as a scalar computing result and the data for determination and outputting a predetermined signal, i.e., an interrupt signal according to a result of the comparison.

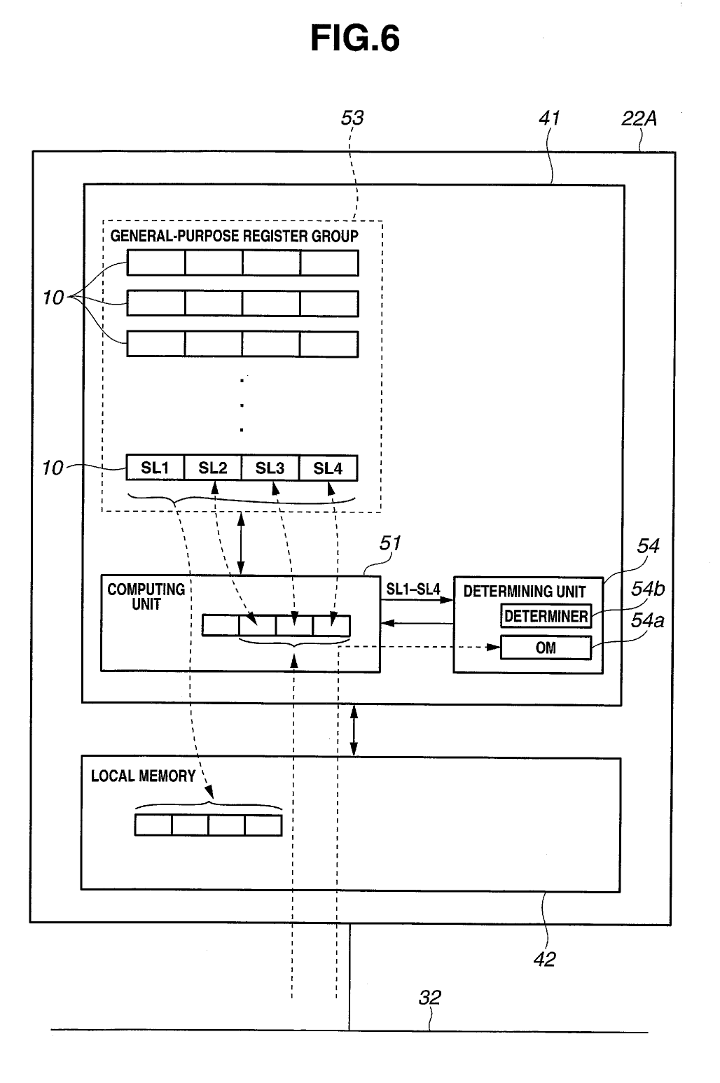

FIG. 6 is a block diagram showing the configuration of the processor according to this embodiment. The same components as those in the first embodiment are denoted by the same reference numerals and signs and explanation of the components is omitted.

A processor 22A includes a determining unit 54 in the calculation unit 41. The determining unit 54 includes a setting register 54a in which the operation mode OM is set. In the setting register 54a, a mode for designating determination processing that should be executed, i.e., an operation mode is set. A setting signal for the operation mode OM is set from outside of the processor 22A, for example, the CPU core 21 via the bus 32.

Data for determination is stored in all of or a part of the vacant slots SL2 to SL4 in the general-purpose register 10 used in the scalar computing. The data is stored in the vacant slots SL2 to SL4 according to an instruction included, i.e., embedded in a debug target program executed in the processor 22A.

The determining unit 54 reads out the data for determination stored in the general-purpose register 10 and executes determination processing corresponding to the set operation mode. A result of the determination processing is output to the computing unit 51 as an interrupt signal.

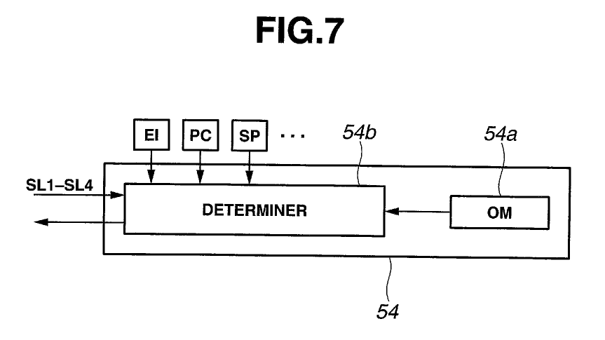

FIG. 7 is a block diagram showing a configuration example of the determining unit 54. The determining unit 54 includes the setting register 54a and a determiner 54b. The determiner 54b of the determining unit 54 is connected to the computing unit 51 and can acquire data necessary for comparison and determination from the computing unit 51. In other words, the determiner 54b is a comparator configured to perform data comparison and determination result output corresponding to the operation mode OM set in the setting register 54a.

The data for determination is data of the general-purpose register 10 supplied from the computing unit 51. Data of slots of the general-purpose register 10 are supplied to the determiner 54b in association with the respective slots. For example, the data of the slots of the general-purpose register 10 are output from the computing unit 51 in predetermined order or respectively output via predetermined signal lines. Therefore, the data from the computing unit 51 is output in association with each of the slots SL1 to SL4.

In other words, the determiner 54b is an output circuit configured to execute, during the scalar computing, determination processing corresponding to the operation mode OM set in the setting register 54a according to the operation mode OM using the data of the slots SL1 to SL4 which is output from the computing unit 51, and output an interrupt signal with respect to a result of the determination.

In the scalar computing, when the scalar computing ends and the computing unit 51 stores a result of the computing in the preferred slot SL1 of the predetermined general-purpose register 10, the computing unit 51 supplies data of the slots SL1 to SL4 of the general-purpose register 10 to the determining unit 54. For example, when the computing unit 51 stores a result of a 32-bit integer computing in the preferred slot SL1 of the predetermined general-purpose register 10, the computing unit 51 outputs the data of the slots SL1 to SL4 of the general-purpose register 10 to the determining unit 54.

The determining unit 54 compares, on the basis of the operation mode OM set in advance, for example, the data of the preferred slot SL1 and the data of the vacant slots SL2 to SL4 and outputs a result of the comparison. For example, when the comparison result matches a predetermined condition, the determining unit 54 outputs a predetermined interrupt signal to the computing unit 51.

As a result, it is possible to inform the user that the comparison result matches the predetermined condition.

### Operation

Operation of the computer system according to this embodiment is explained below. When a debug program is executed in the main body unit 11 of the computer system, an operation mode is set in advance in the setting register 54a of the determining unit 54 of each of the processors.

As explained above, the operation mode indicates content of determination processing and indicates which pieces of data are compared and how the pieces of data are compared and in what kind of a result of the comparison an interrupt signal is output.

For example, when the user finds a deficiency in a development program, the user may desire to cause the computer system to execute a portion of the scalar computing related to the occurrence of the deficiency and check whether data of a result of the scalar computing is a value within a predetermined range. Specifically, during the scalar computing, the user can learn that the computing result data is outside the predetermined range by causing the computer system to compare the computing result data and a minimum and a maximum in the predetermined range and, when the computing result data is outside the predetermined range, causing the computer system to generate an interrupt signal.

In such a case, the user embeds, in the debug target program, an instruction for causing the computer system to store in advance data of the minimum and data of the maximum respectively in the slots SL2 and SL3 of the predetermined general-purpose register 10. In other words, in performing debugging, the user adds in advance, in the debug target program, an instruction for causing the computer system to store predetermined data for determination in a vacant slot of a predetermined general-purpose register.

The user sets in advance the operation mode OM to a mode for comparing a value of the preferred slot SL1 and the minimum and the maximum to determine whether the value is in the range of the minimum and the maximum.

When the debug target program is executed, the instruction embedded in the debug target program writes the data of the minimum and the data of the maximum in the slots SL2 and SL3 at a first stage. Thereafter, a body of the debug target program is executed.

As a result, when the scalar computing is executed during the execution of the debug target program, the determiner 54b compares the computing result data stored in the preferred slot SL1 and the minimum and the maximum stored in the slots SL2 and SL3. When the computing result data is not within the predetermined range, the determiner 54b outputs a predetermined interrupt signal to the computing unit 51.

The user may desire to detect whether a calculation result of the scalar computing coincides with a predetermined value. In such a case, the user embeds data of the predetermined value in the debug target program such that the data is stored in the slot SL2. The user sets the operation mode to a mode for comparing a value (i.e., computing result data) of the preferred slot SL1 and the predetermined value to determine whether the value of the preferred slot SL1 coincides with the predetermined value and, when the value of the preferred slot SL1 coincides with the predetermined value, outputting the predetermined interrupt signal to the computing unit 51.

In the setting of the operation mode, the example explained above concerning the comparison data and the content of the comparison is only an example. Other examples will be explained in detail later.

A flow of processing during the execution of the debug processing is the same as that of the processing shown in FIG. 5. Specifically, before causing the computer system to execute a debug target program, the user performs setting of an operation mode on the debug processing program (step S1). As a result, as indicated by a dotted line in FIG. 6, the operation mode OM is set in the setting register 54a.

As in the first embodiment, the setting of an operation mode is performed by, for example, causing the computer system to display a setting screen on the screen of the monitor 13 and selecting an operation mode indicating a register which the user desires to store in each of one or two or more vacant registers, out of a plurality of displayed operation modes.

After performing the setting of the operation mode, the user causes the computer system to execute a program having a deficiency on the debug program (step S2). In other words, execution of the debug target program is performed. The writing of the data for determination in the vacant slot explained above is performed in first processing during the execution of the debug target program.

When the program is executed, as in the first embodiment, if an execution instruction is an SIMD instruction, the SIMD computing is performed by using all the four slots.

If the execution instruction is an instruction of the scalar computing, when the computing unit 51 stores a computing result in the preferred slot SL1 in the predetermined general-purpose register 10, the computing unit 51 supplies data of the slots SL1 to SL4 of the general-purpose register 10 to the determining unit 54.

As a result, the determining unit 54 executes determination processing by a predetermined comparison computing on the basis of the set operation mode OM and supplies a determination result to the computing unit 51 as an interrupt signal. For example, when a computing result is a value within a predetermined range, an interrupt signal is not generated. However, when the computing result is outside the predetermined range, an interrupt signal is generated.

Predetermined interrupt processing is executed according to the generated interrupt signal. For example, processing for displaying, on the screen of the monitor 13, an indication that a value of the preferred slot SL1 (i.e., a computing result) is outside a range of a minimum and a maximum of the slots SL2 and SL3 and notifying the user of the same is executed. Therefore, during the scalar computing, the user can cause the monitor 13 to display computing result data at the time of the generation of the interrupt signal and can check the computing result data.

In this embodiment, as indicated by the dotted line in FIG. 6, without depending on a dedicated store instruction for each size of the slots, a value stored in the vacant slot can be stored in the local memory 42 together with a value stored in the preferred slot.

### Examples of the Data for Determination and the Determination Processing

Examples of the data for determination and the determination processing are explained below.

### 1) Limitation Concerning the Stack Pointer

In the case of a processor implemented to use a general-purpose register as a stack pointer, a value of the stack pointer (SP) is stored in the preferred slot SL1 of the predetermined general-purpose register. In such a case, a person who performs debugging adds, in the debug target program, an instruction for setting limit value data of the stack pointer (SP), which is calculated from a program being executed, in the vacant slot SL2 of the general-purpose register in which the value of the stack pointer (SP) is stored. The person who performs debugging sets, in the setting register 54a of the determining unit 54, the operation mode OM for generating an exception when the value of the stack pointer (SP) exceeds the limit value.

For example, when a so-called attacker to a computer causes the computer to process malicious data, a stack increases to be larger than an assumption of a programmer, and a value of the stack pointer (SP) indicates an area for storing data, in the past, for example, stack overflow occurs, a program intended by the attacker is executed, data stored in a memory is destroyed, or the system becomes unstable. In such a case, if the processor according to this embodiment is used, a range of values that could be taken by the stack pointer (SP) is limited in advance and an exception is generated when the stack pointer (SP) takes a value in a range outside the assumption. This makes it possible to cope with such an attack or a problem in program execution and is useful for improving stability of the computer system.

### 2) Check of a Value of the Program Counter

There is a general-purpose register such as a stack pointer (SP) in which it is found in advance that a scalar value is accessed during execution of a program. In such a case, the person who performs debugging adds, in the debug target program, an instruction for setting a maximum and a minimum of the program counter (PC) at the time when the register is accessed. The person who performs debugging sets, in the setting register 54a of the determining unit 54, the operation mode OM for generating an exception when a value of the program counter (PC) is outside a range of the maximum and the minimum.

Consequently, it can be guaranteed that a program being executed is always in a domain assumed by a program created by a programmer in advance. Therefore, when an attacker causes a processor to process malicious data, this makes it difficult to execute an instruction for such an attack and is useful for improving safety of the computer system.

### 3) Fixing of a Location Accessible to a Variable

The person who performs debugging adds, in the debug target program, an instruction for setting, in a vacant slot of a general-purpose register in which a scalar value is stored, a type of an instruction set of a program that can overwrite the stored scalar value or a range of a program counter in which a numerical value of the scalar value can be overwritten. The person who performs debugging sets, in the setting register 54a of the determining unit 54, the operation mode OM for generating an exception when an instruction set or a value of the program counter (PC) that does not match the designated type of the instruction set or the designated range of the program counter (PC) is generated.

This makes it possible to narrow down conditions concerning access to a certain variable and therefore is useful for, for example, analysis of a cause during debugging.

As explained above, if the processor according to this embodiment is used, the program developer can not only easily check, for example, whether content of computing result data or the like matches a predetermined condition during the scalar computing but also easily change, by changing an operation mode, content that the program developer desires to check.

In the example explained above, the determining unit 54 is configured to acquire the data for determination from the computing unit 51. However, as explained in the first embodiment, the determining unit 54 may be configured to be capable of acquiring the data for determination from various registers.

As explained above, usually, when the processor in the past calculates, for example, a 32-bit integer, data used for a computing is stored in the position of the byte indexes 0 to 3 of the general-purpose register. However, the areas of the remaining byte indexes 4 to 15 are not used. A computing result is stored in only the byte indexes 0 to 3 of the general-purpose register. Values of the vacant slots of the byte indexes 4 to 15 are not changed.

On the other hand, in the embodiments explained above, the desired data as the additional information or the data for determination is stored in the storage area of the general-purpose register not used when a scalar value is stored, i.e., by using the vacant slot. As a result, the person who performs debugging can check content of data stored in the vacant slot or learn a determination result based on a result of the predetermined comparison of the data for determination stored in the vacant slot and a computing result or the like.

As explained above, with the processor according to the embodiments, it is possible to store, without separately providing a register for debugging for storing values of registers in the processor, the values of the registers. As a result, it is possible to easily find, during program development, operation or the like not intended by the program developer. Therefore, efficiency of development of a program is improved.

In the embodiments, one selecting unit and one determiner are provided in each processor. However, a plurality of selecting unit and a plurality of determiners may be provided.

The present invention is not limited to the embodiments. It is possible to perform various modifications, alterations, and the like of the embodiments without departing from the spirit of the present invention.

What is claimed is:

1. A processor comprising:
a setting register in which a mode is set;
at least one general-purpose register including a first area used during a predetermined computing and a second area not used during the predetermined computing;
a computing unit configured to execute the predetermined computing using the first area of the at least one general-purpose register and store computing result data of the predetermined computing in the first area of the at least one general-purpose register; and
an output circuit configured to select data of the at least one register in the processor according to the mode set in the setting register during the predetermined computing and output the data to the second area or execute determination processing corresponding to the mode set in the setting register using the data stored in the first area and the second area during the predetermined computing and output a predetermined signal to the computing unit with respect to a result of the determination processing.

2. The processor according to claim 1, wherein
the predetermined computing is a scalar computing, and
the computing unit can execute the scalar computing and a vector computing that uses the first area and the second area of the at least one general-purpose register.

3. The processor according to claim 1, wherein the at least one register is a register for a program counter in the processor, a register for a stack pointer in the processor, or a register for an execution instruction executed by the processor.

4. The processor according to claim 1, wherein the predetermined signal is a predetermined interrupt signal.

5. The processor according to claim 1, wherein the determination processing designated by the mode is processing for determining whether the computing result data of the predetermined computing stored in the first area is a value in a range set by the data stored in the second area.

6. The processor according to claim 1, wherein the determination processing designated by the mode is processing for determining whether the computing result data of the predetermined computing stored in the first area coincides with the data stored in the second area.

7. A processor comprising:
a setting register in which a mode for designating data of at least one register in the processor is set;
at least one general-purpose register including a first area used during a predetermined computing and a second area not used during the predetermined computing;
a selector configured to select and output data of the at least one register designated by the mode set in the setting register during the predetermined computing; and
a computing unit configured to execute the predetermined computing using the first area of the at least one general-purpose register and store computing result data of the predetermined computing in the first area of the at least one general-purpose register, wherein
the data of the at least one register output from the selector is stored in the second area of the at least one general-purpose register.

8. The processor according to claim 7, wherein the data of the at least one register output from the selector is stored in the second area of the at least one general-purpose register by the computing unit or the selector.

9. The processor according to claim 7, wherein
the predetermined computing is a scalar computing, and
the computing unit can execute the scalar computing and a vector computing that uses the first area and the second area of the at least one general-purpose register.

10. The processor according to claim 7, wherein a setting signal for setting the mode is given from outside of the processor and supplied to the setting register.

11. The processor according to claim 7, wherein the at least one register is a register for a program counter in the processor.

12. The processor according to claim 7, wherein the at least one register is a register for a stack pointer in the processor.

13. The processor according to claim 7, wherein the at least one register is a register for an execution instruction executed by the processor.

14. The processor according to claim 7, wherein the at least one register is a register for computing result data of the predetermined computing in the processor.

15. A processor comprising:
a setting register in which a mode for designating determination processing is set;
at least one general-purpose register including a first area used during a predetermined computing and a second area not used during the predetermined computing;
a computing unit configured to store, during execution of the predetermined computing, computing result data of the predetermined computing in the first area of the at least one general-purpose register and output data stored in the first area and the second area; and
a determiner configured to execute the determination processing designated by the mode set in the setting register using the data output from the computing unit during the predetermined computing and stored in the first area and the second area, and output a predetermined signal to the computing unit with respect to a result of the determination processing.

16. The processor according to claim 15, wherein
the predetermined computing is a scalar computing, and
the computing unit can execute the scalar computing and a vector computing that uses the first area and the second area of the at least one general-purpose register.

17. The processor according to claim 15, wherein the data in the second area is stored according to an instruction included in a program executed in the processor.

18. The processor according to claim 15, wherein the predetermined signal is a predetermined interrupt signal.

19. The processor according to claim 15, wherein the determination processing designated by the mode is processing for determining whether the computing result data of the predetermined computing stored in the first area is a value in a range set by the data stored in the second area.

20. The processor according to claim 15, wherein the determination processing designated by the mode is processing for determining whether the computing result data of the predetermined computing stored in the first area coincides with the data stored in the second area.
